(19) United States
(12) Patent Application Publication
(10) Pub. No.: US 2016/0125361 A1
(43) Pub. Date: May 5, 2016

(54) AUTOMATED JOB INGESTION

(71) Applicant: LinkedIn Corporation, Mountain View, CA (US)

(72) Inventors: Eduardo Vivas, Miami, FL (US); Anthony Duane Duerr, Castro Valley, CA (US); Aaron Tyler Rucker, San Francisco, CA (US); Nikko David Bautista, San Francisco, CA (US); Iain MacNaughton, San Francisco, CA (US); Rafael E. Crespo, San Francisco, CA (US); Kyle Sosnowski, San Francisco, CA (US); Christophe Boudet, San Francisco, CA (US); Nitin Perumbeti, San Francisco, CA (US)

(21) Appl. No.: 14/555,327

(22) Filed: Nov. 26, 2014

Related U.S. Application Data
(60) Provisional application No. 62/072,934, filed on Oct. 30, 2014.

(51) Int. Cl. G06Q 10/10; G06Q 50/00; G06F 17/30

(52) U.S. Cl. CPC G06Q 10/1053; G06F 17/30312; G06F 17/30882; G06Q 50/01

(57) ABSTRACT

Techniques for ingesting job listings are described. A job ingestion module of a social network system can access a seed uniform resource locator (URL), and identify a job URL from the seed URL. Additionally, the job ingestion module can obtain job attributes from the job URL. Furthermore, the job ingestion module can validate the obtained field attributes using member data from the social network system. Moreover, the job ingestion module can generate a job listing based on the validated job attributes. Subsequently, the job ingestion module can post the generated job listing.

### CROSS-REFERENCE TO RELATED APPLICATIONS

This application claims priority to U.S. Provisional Application No. 62/072,934, filed Oct. 30, 2014, entitled “AUTOMATED JOB INGESTION,” which is incorporated herein by reference in its entirety.

### TECHNICAL FIELD

The subject matter disclosed herein generally relates to data processing systems for hosting job postings. Specifically, the present disclosure generally relates to techniques for ingesting a basic job posting in order to upgrade the posting to a premium job posting in a social network.

### BACKGROUND

With a typical job hosting service, a representative of a company will post a job listing to the job hosting service so that users of the job hosting service can search for, browse, and in some cases, apply for the job associated with the particular job listing. Additionally, the job listing may have to be posted on a plurality of job hosting services in order for the job listing to reach a larger audience.

Social networking websites can maintain information on members, companies, organizations, employees, and employers. The social networking websites may also include a job hosting service, which can include job postings for a potential employer. In some instances, a job posting can be accessed from a third-party website in order to generate a centralized job hosting service for all job postings. However, some useful marketing information may be missing in the third-party job posting, and some the third-party job posting may be need to be validated.

### BRIEF DESCRIPTION OF THE DRAWINGS

Some embodiments are illustrated by way of example and not limitation in the figures of the accompanying drawings.

FIG. 1 is a network diagram illustrating a network environment suitable for a social network, according to some example embodiments.

FIG. 2 is a block diagram illustrating various modules of a social network service, according to some example embodiments.

FIG. 3 is a block diagram illustrating various module of the job ingestion module, according to some example embodiments.

FIG. 4 is a flowchart illustrating a method for ingesting job listings, according to some example embodiments.

FIG. 5 is an example of a job uniform resource locator (URL), according to some example embodiments.

FIG. 6 illustrates an example of a job listing having job attributes, according to some example embodiments.

FIG. 7 illustrates an interface for an analyst to select the field attributes of a job listing, according to some example embodiments.

FIG. 8 illustrates an interface for an analyst to verify the field attributes of a job listing, according to some example embodiments.

FIG. 9 is a flowchart illustrating another method for ingesting job listings, according to some example embodiments.

FIG. 10 illustrates an interface for an administrator to manage the workflow for a team of analysts, according to some example embodiments.

FIG. 11 is a block diagram illustrating components of a machine, according to some example embodiments, able to read instructions from a machine-readable medium and perform any one or more of the methodologies discussed herein.

### DETAILED DESCRIPTION

The present disclosure describes methods, systems, and computer program products for ingesting job listings from third-party websites. Using social graph information and member behavior data in the social network system, embodiments of the present disclosure can determine the validity of the job listing and the validity of the field attributes of the job listings. Additionally, social graph information and member behavior data can be used to determine information that may be missing from the third-party job listing.

In a social network system, social graph information and member behavior data are based on member profiles and company pages. For example, a member of a social network can create a member profile. The member profile can include a location associated with the member, a company listed as the member's current employer, and the member's job title. In addition to member profiles, a social network system can have company pages with information relating to the company, such as the executive team and the office locations.

Consistent with some embodiments, a job hosting service of a social network system can have bifurcated functions and features for job listings (sometimes referred to as job postings). For example, via a job posting module of the job hosting service, users of the job hosting service can provide information about a particular job opening and generate a paid job listing. A job listing typically is comprised of the name of the company or organization at which the job opening is available, the job title for the job opening, a description of the job functions, and the recommended skills, education, certifications and/or expertise. In exchange for the payment of the fee, the paid job posting will be eligible for presentation to members of a social networking service with which the job hosting service is integrated.

In addition to paid job postings, the job hosting service may ingest job listings from various externally hosted third-party job sites. In some instances, a job ingestion module may automatically “crawl” and discover job listings for ingestion, while in other instances, job listings may be obtained from a data feed maintained by one or more third-party partners. In any case, the job hosting service will have a database containing both paid job listings—that is, job listings that have been generated through a job posting module and for which a fee has been obtained—and, unpaid job listings—that is, job listings obtained from a third-party site.

Example methods and systems are directed to techniques for automating job ingestion from third-party job sites using a job ingestion module. Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

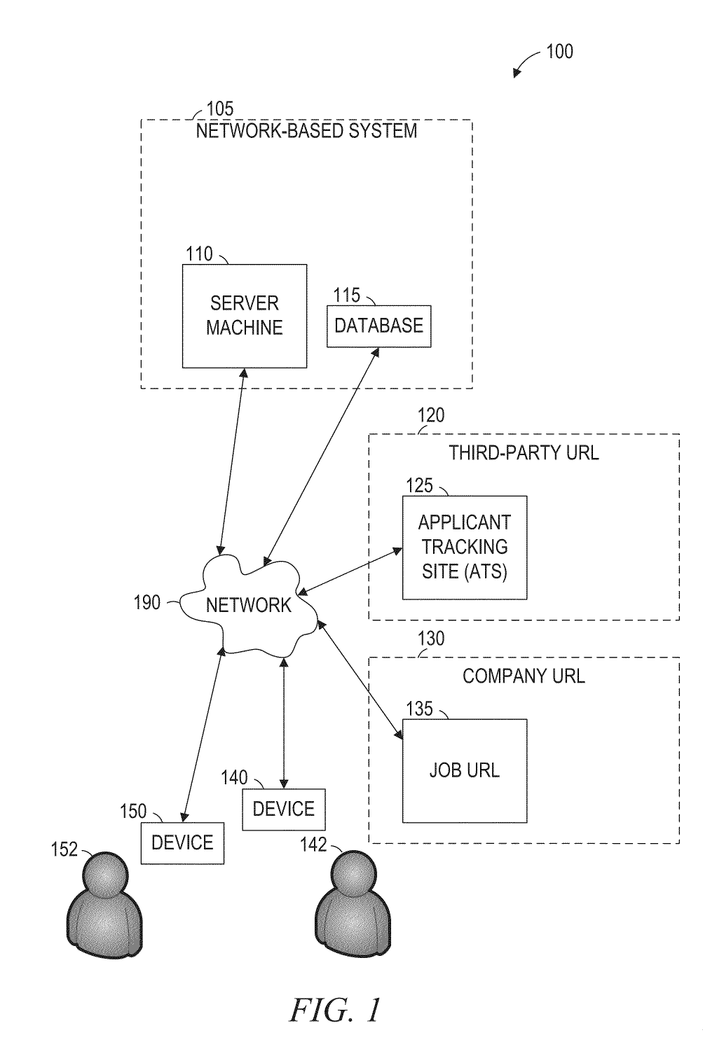

FIG. 1 is a network diagram illustrating a network environment 100 suitable for a social network service, according to some example embodiments. The network environment 100 includes a server machine 110, a database 115, a first device 140 for a user 142, and a second device 150 for an analyst 152, all communicatively coupled to each other via a network 190. The server machine 110 may form all or part of a network-based system 105 (e.g., a cloud-based server system configured to provide one or more services to the devices 140 and 150). The database 115 can store job listings for the social network service that are either uploaded by a member or ingested using the job ingestion module.

For example, the job ingestion module can ingest job listings from a third-party uniform resource locator (URL) 120 or a company URL 130. The third-party URL 120 can have job listings that may be stored in an applicant tracking system (ATS) 125. The ATS 125 can be a software application that enables the electronic handling of recruitment needs. The ATS 125 can be designed for recruitment tracking purposes. Alternatively, the company URL 130 associated with company X can post job listings for company X on a job URL 135. The job URL 135 can list available job listing directly on the company URL 130. The ingested job listings can be retrieved using network 190.

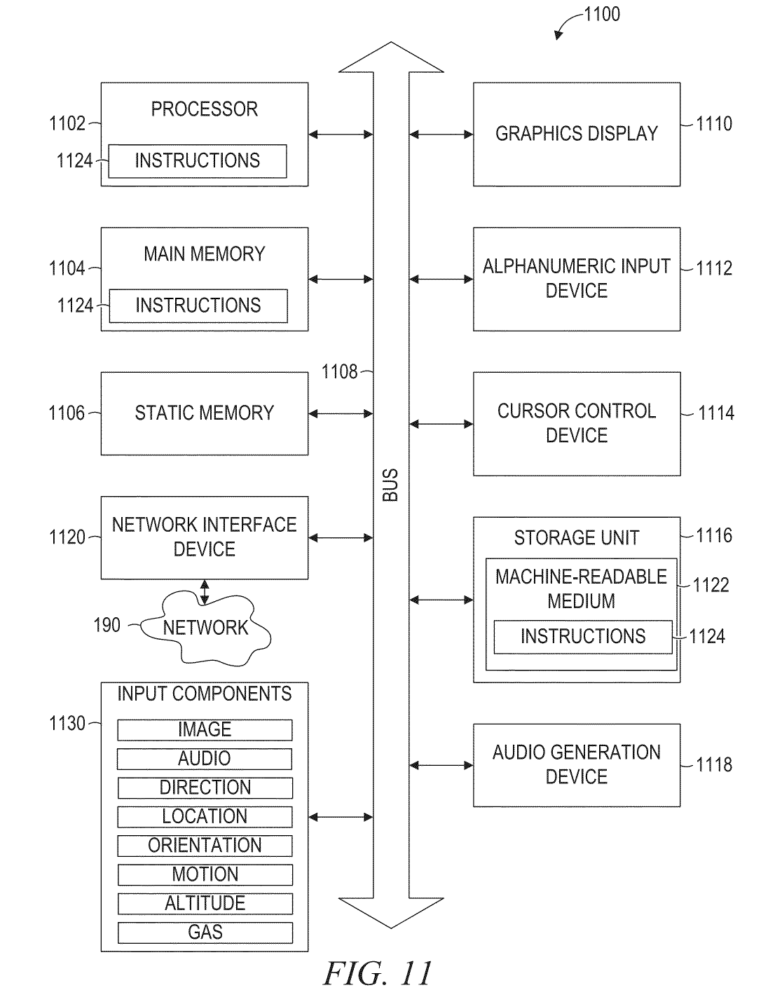

Additionally, the server machine 110, the first device 140, and the second device 150 may each be implemented in a computer system, in whole or in part, as described below with respect to FIG. 11.

Also shown in FIG. 1 are user 142 and analyst 152. One or both of the user 142 and analyst 152 may be a human user (e.g., a human being), a machine user (e.g., a computer configured by a software program to interact with the device 140 or 150), or any suitable combination thereof (e.g., a human assisted by a machine or a machine supervised by a human). The user 142 is not part of the network environment 100, but is associated with the device 140 and may be a user of the device 140. For example, the device 140 may be a desktop computer, a vehicle computer, a tablet computer, a navigational device, a portable media device, a smartphone, or a wearable device (e.g., a smart watch or smart glasses) belonging to the user 142. Likewise, the analyst 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the analyst 152. In some instances, the analyst 152 can also be an administrator for the job ingestion system.

Any of the machines, databases, or devices shown in FIG. 1 may be implemented in a general-purpose computer modified (e.g., configured or programmed) by software (e.g., one or more software modules) to be a special-purpose computer to perform one or more of the functions described herein for that machine, database, or device. For example, a computer system able to implement any one or more of the methodologies described herein is discussed below with respect to FIG. 11. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the server machine 110 and the device 140). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

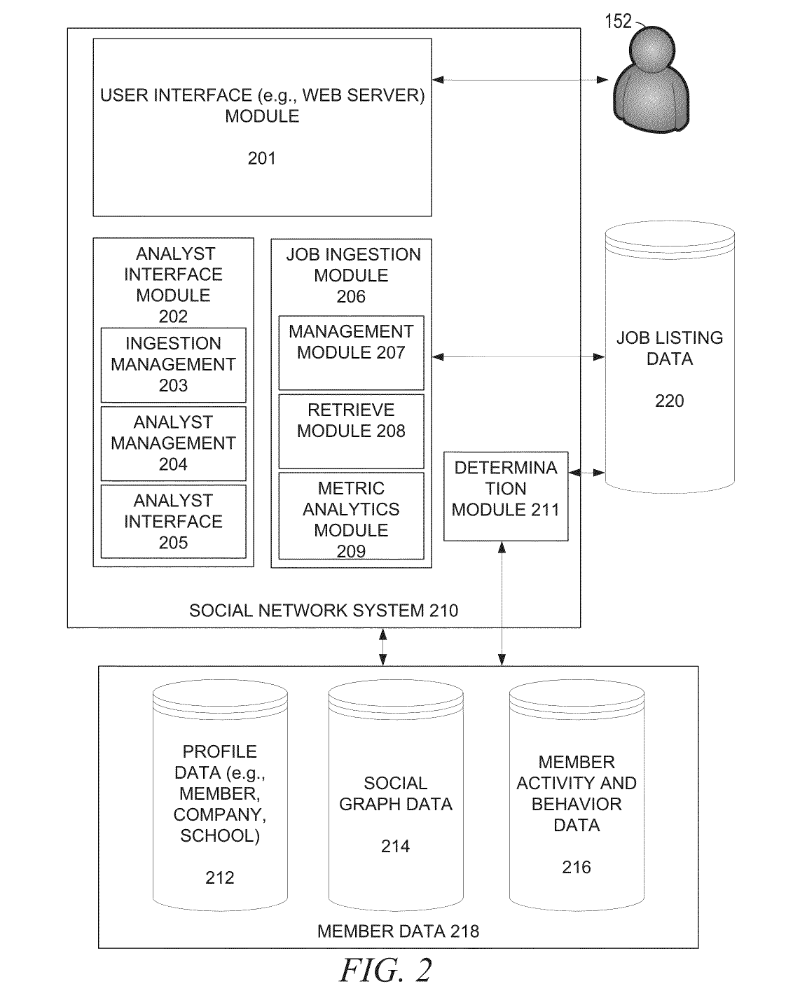

FIG. 2 is a block diagram illustrating components of a social network system 210, according to some example embodiments. The social network system 210 is an example of a network-based system 105 of FIG. 1. The social network system 210 can include a user interface module 201, an analyst interface module 202, an job ingestion module 206, and a determination module 211 all configured to communicate with each other (e.g., via a bus, shared memory, or a switch).

The user interface module 201 can present job listings, accessed from job listing data 220, to a user 152. The job listing data 220 can include jobs listed by member of the social network system 210 and job listings ingested by the job ingestion module 206.

The analyst interface module 202 can allow the analyst 152 or the administrator to perform tasks for ingesting job listings that can stored in the job listing data 220. The analyst interface module 202 can include an ingestion management 203, analyst management 204, and analyst interface 205.

For example, the ingestion management 203 can allow administrators to enable and disable sites for ingestion, look at statistics, edit ingestion output and manage a location database associated with the job ingestion module 206.

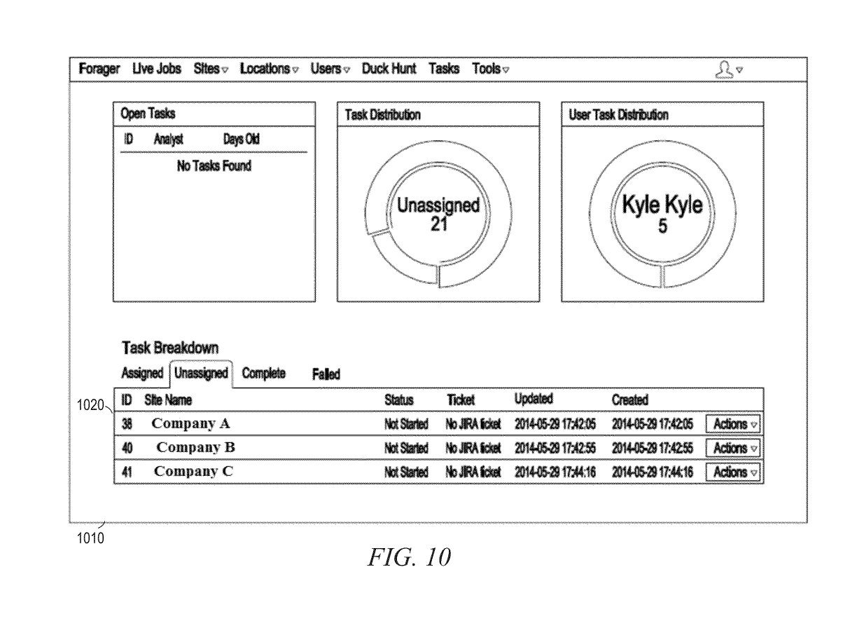

The analyst management 204 can allow administrators to manage a team of analysts and see their output, as illustrated by FIG. 10. For example, the analyst management 204 can give analysts different access rights to the job listing data 220 based on location.

Furthermore, the analyst interface 205 can allow analysts (e.g., analyst 152) to perform tasks for ingestions. Some of the tasks associated with an analyst can include rule creation and rule verification. Rule creation can allow localized analysts (e.g., French analysts creating rules for Canadian sites) to create ATS-level ingestion rules for automatic ingestion of a site without having an engineer build an ingester. Rule verification can allow analysts to verify that an ingestion rule set is working correctly.

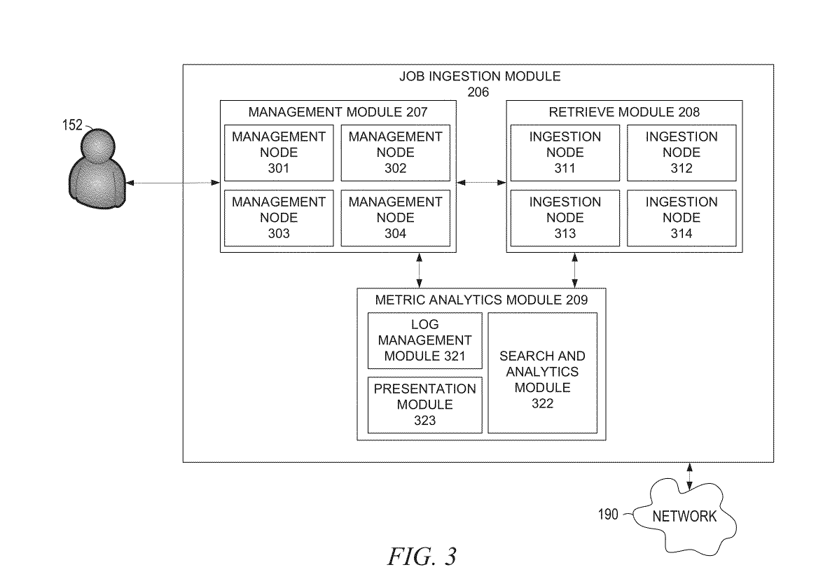

The job ingestion module 206 can automate the retrieval of job listings that are originally posted outside the social network system 210. The job ingestion module 206, which includes a management module 207, a retrieve module 208, and a metric analytics module 209, is further described in FIG. 3.

Additionally, the social network system 210 can communicate with database 115 of FIG. 1, such as a database storing member data 218 and job listing data 220. The member data 218 can include profile data 212, social graph data 214, and member activity and behavior data 216. Using the member data 218 and the job listing data 220, a determination module 211 can determine features missing from the ingested job listing.

Furthermore, the determination module 211 can determine the validity (e.g., authenticity) of job listings from a third party based on the member data 218 and the job listing data 220. For example, using the skills, job title, job function, and industry information in the profile data 212, the determination module 211 can determine if the job listing is valid.

Any one or more of the modules described herein may be implemented using hardware (e.g., one or more processors of a machine) or a combination of hardware and software. For example, any module described herein may configure a processor (e.g., among one or more processors of a machine) to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

As shown in FIG. 2, member data 218 includes several databases, such as a database for storing profile data 212, including both member profile data as well as profile data for various organizations. Additionally, the member data 218 can include a database for social graph data 214 and member activity and behavior data 216.

Profile data 212 can be used to determine entities (e.g., company, organization) associated with a member. For instance, with many social network services, when a user registers to become a member, the member is prompted to provide a variety of personal and employment information that may be displayed in a member's personal web page. Such information is commonly referred to as profile data 212. The profile data 212 that is commonly requested and displayed as part of a member's profile includes educational background (e.g., schools, majors, matriculation and/or graduation dates, etc.), employment history, office location, skills, professional organizations, and so on.

In some embodiments, profile data 212 may include the various skills that each member has indicated he or she possesses. Additionally, profile data 212 may include skills for which a member has been endorsed in the profile data 212.

In some other embodiments, with certain social network services, such as some business or professional network services, profile data 212 may include information commonly included in a professional resume or curriculum vitae, such as information about a person's education, the company at which a person is employed, the location of the employer, an industry in which a person is employed, a job title or function, an employment history, skills possessed by a person, professional organizations of which a person is a member, and so on.

Another example of profile data 212 can include data associated with a company page. For example, when a representative of an entity initially registers the entity with the social network service, the representative may be prompted to provide certain information about the entity. This information may be stored, for example, in the database 115, and displayed on a company page.

Additionally, social network services provide their users with a mechanism for defining their relationships with other people. This digital representation of real-world relationships is frequently referred to as social graph data 214.

In some instances, social graph data 214 can be based on an entity's presence within the social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations and/or relationships between the different entities.

Member activity and behavior data 216 can include members' interaction with the various applications, services, and content made available via the social network service, and the members' behavior (e.g., content viewed, links selected, etc.). For example, the social network service may provide a broad range of other applications and services that allow members the opportunity to share and receive information, often customized to the interests of the member. In some embodiments, members may be able to self-organize into groups, or interest groups, organized around subject matter or a topic of interest. In some embodiments, the social network service may host various job listings providing details of job openings with various organizations.

FIG. 3 is a block diagram illustrating components of the job ingestion module 206, according to some example embodiments. The job ingestion module 206 can include a management module 207, a retrieve module 208, and a metric analytics module 209.

In some instances, the job ingestion module 206 can ingest (e.g., retrieve, access, crawl for) jobs from different applicant tracking system (ATS) (e.g., third-party URL 120) or company website (e.g., company URL 130) using network 190. As previously described in FIG. 2, the ingested jobs can be stored in the job listing data 220.

The management module 207 can allow administrators to view current ingestions. The management module 207 can contain a plurality of management nodes (e.g., management node 301, management node 302, management node 303, and management node 304). For example, most of the logic regarding ingested items (e.g., jobs) can be stored in a management node (e.g., management node 301). Additionally, the scheduling and management of the ingestion can be stored in a management node (e.g., management node 301). Furthermore, the management module 207, along with the analyst interface module 202, can present an interface for administrators and analysts to perform their duties.

The retrieve module 208 can contain a plurality of ingestion nodes (e.g., ingestion node 311, ingestion node 312, ingestion node 313, and ingestion node 314). An ingestion node (e.g., ingestion node 311) can receive instructions from a specific management node (e.g., management node 301) to ingest job listings from a third-party URL 120. For example, different ingestion nodes (e.g., ingestion node 311) can have custom for a specific ATS (e.g., ATS 125).

The metric analytics module 209 can be a logging and metrics analytics system that allows administrators to analyze logs received from a management node (e.g., management node 301). The metric analytics module 209 can include a log management module 321, a search and analytics module 322, and a presentation module 323.

The log management module 321 can manage events and log. The log management module 321 can be installed on each management node (e.g., management node 301) and can be responsible for accessing the log files and transmitting the log files to the search and analytics module 322. The log management module 321 can allow the metric analytics module 209 to keep logging without adding additional latency to insert directly into search and analytics module 322.

The search and analytics module 322 can make data easy to explore and searchable. For examples, logs can be stored in the search and analytics module 322 and indexed to make the logs searchable.

The presentation module 323 can interact directly with the search and analytics module 322 and present log information to an administrator or analyst 152. For example, the presentation module 323 can include an interface which allows a query by time and type of event, and calculates averages over time. The presentation module 323 can be tailored to present dashboards that display statistics based on specific log entries. In some instances the presentation module 323 can be part of the analyst interface module 202.

In some instances, a representational state transfer (REST) application programming interface (API) can facilitate communication between the management module 207 and the retrieve module 208. The management module 207 can have an endpoint for ingested jobs to be sent back from the retrieve module 208, and endpoints that are called by the retrieve module 208 to signal that an ingestion has begun or ended. The endpoints can be secured by allowing access from certain internet protocol (IP) address, signature verification, authentication, and IP banning. The signature verification can ensure that API calls have been signed with a key in order to verify the authenticity of the API request. The authentication can be a hypertext transfer protocol (HTTP) authentication after the signature verification. The IP banning can include banning an IP address after a specific number of unauthenticated API requests. Additionally, the API endpoints can be secured using a virtual private network (VPN), which makes it only accessible within the network of the management module 207.

Additionally, the job ingestion module 206 can be configured to process data offline or periodically. For example, job ingestion module 206 can include Hadoop servers that access ATS 125, job URL 135, member data 218, and job listing data 220 periodically in order to periodically update job listings stored in the job listing data 220. Processing and ingesting the millions of job listings may be computationally intensive; therefore, due to hardware limitations and to ensure reliable performance of the social network, the determination may be done offline.

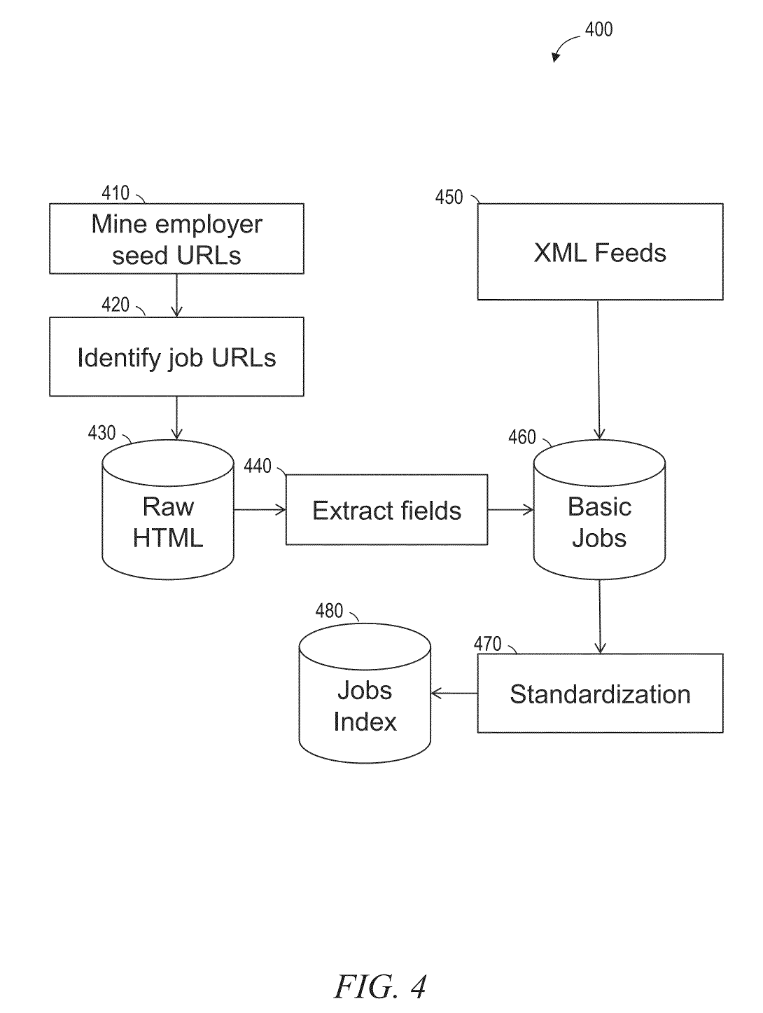

FIG. 4 is a flowchart illustrating operations of the job ingestion module 206 in performing a method 400, according to some example embodiment.

In some instances, a time-based scheduler can get called to begin scheduling new ingestions using the management node 301. The management node 301 can determine which at sites (e.g., company URL 130) to schedule a new ingestion.

At operation 410, the job ingestion module 206, using management node 301, can mine employer seed URLs (e.g., company URL 130). For example, several tools (e.g., a search engine optimization tool, user input of seed URL, crawling of directories, crawling of search result pages) can be used to discover company URLs 130 in order to ingest jobs listings.

At operation 420, the job ingestion module 206 can identify a job URL. For example, the management node 301 can identify a job URL (e.g., job URL 135) with posted job listings. The job URL 135 can be accessed from a job section tab of the home page of the company URL 130. An ingestion node 311 can receive a command from the management node 301 to schedule the ingestion. The ingestion node 311 can send back a notification to the management node 301 that the ingestion has started on a particular site (e.g., company URL 130).

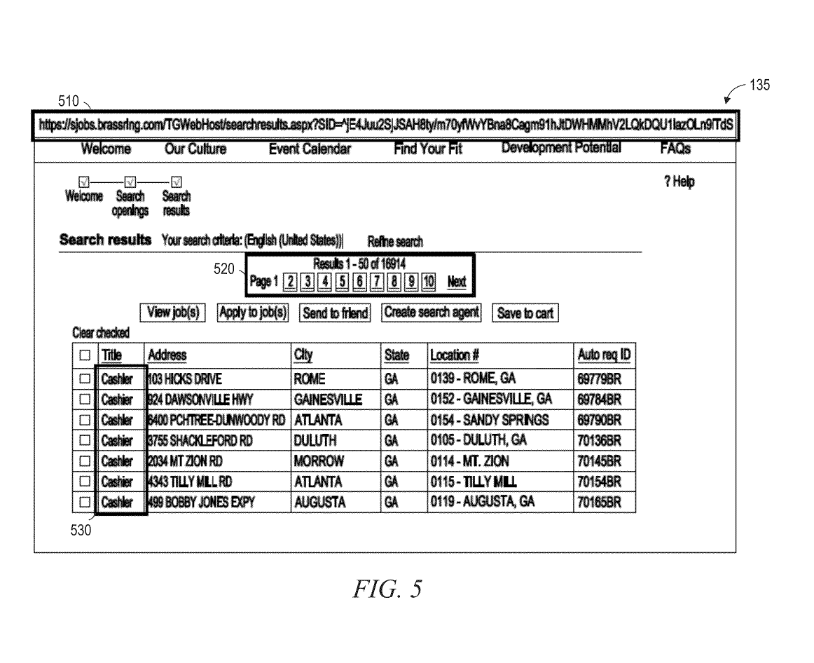

FIG. 5 further illustrates an example of a job URL 135. The job URL 135 can have a specific URL 510 associated with the job listings webpage. Additionally, as illustrated with the page results 520, the company URL 130 can have a plurality of job URLs 135. The management node 301 and the ingestion node 311, using rules to handle pagination, can ingest each specific URL 510 (e.g., page 1, page 2 . . . and page 10) from the page results 520 in order to ingest all of the job listings. Additionally, as illustrated in this example, the job listings can be ordered and ingested by job title 530.

At operation 430, raw HTML can be extracted from the identified job URL 135. For example, the ingestion node 311 can then perform the ingestion by extracting raw HTML from the job URL 135, and sending back each ingested item (e.g., job listing) to the management node 301.

At operation 440, the job ingestion module 206 can extract fields from the raw HTML. For example, the management node 301 and the ingestion node 311 can extract fields from a job listing in the job URL 135.

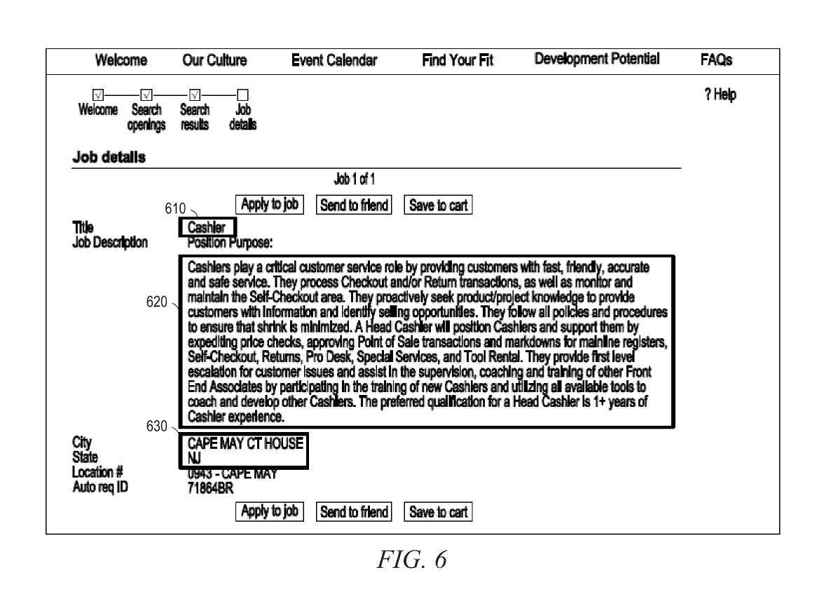

FIG. 6 further illustrates and example of the job ingestion module 206 extracting fields from the raw HTML. The job ingestion module 206 can define rules to extract the title field 610, description field 620, and location field 630 from each job listing's raw HTML.

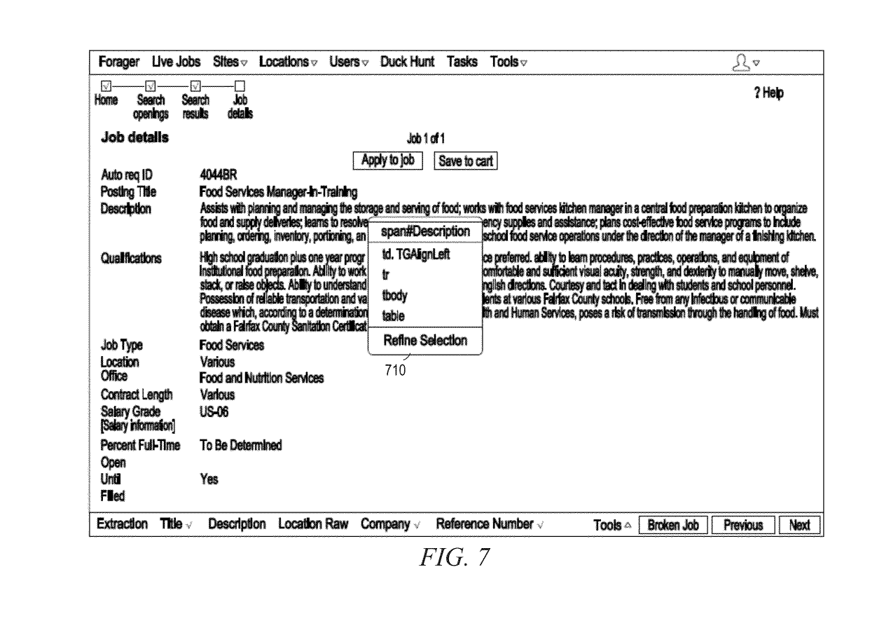

FIG. 7 illustrates an interface for an analyst 152 to extract a field (e.g., description field 620) from the raw HTML, according to another embodiment. For example, the job ingestion module 206 can determine that the extract field is the description field 620, or alternatively, interface 710 can be used by the analyst 152 to extract the description field 620 from the raw HTML. Furthermore, once the description field 620 has been determined for a first job listing, using machine learning techniques, the job ingestion module 206 can determine the description field 620 for all the other job listings in the job URL 135.

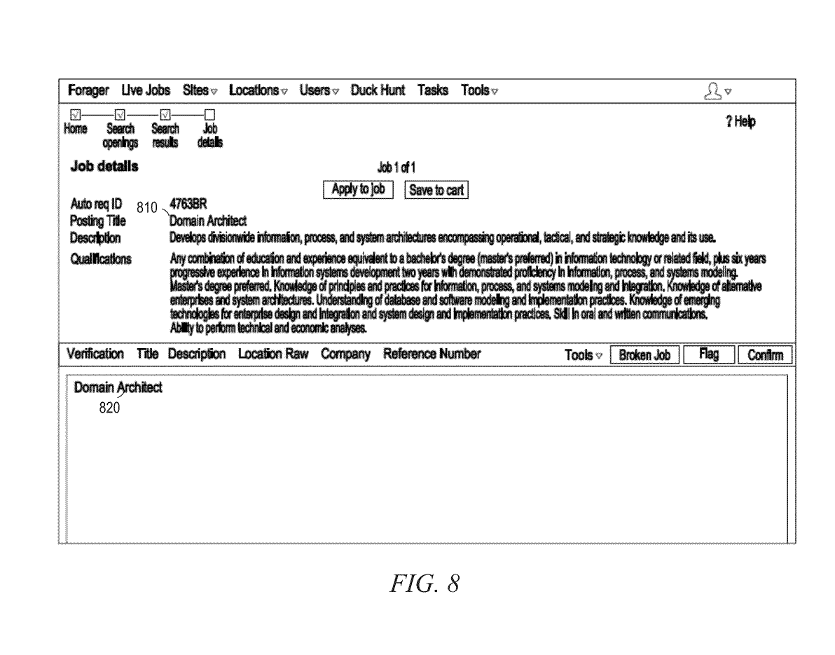

In some instances, to ensure high accuracy of the job listings on the social network system 210, the information extracted by the job ingestion module 206 can be verified using an analyst 152. As illustrated in FIG. 8, the analyst 152 can verify that “Domain Architect” 820 is the correct information extracted from the title field 810.

In some instances, an API from the job ingestion module 206 can be used to map raw location strings to standardized cities, states, countries, and postal codes. The raw location strings can be information accessed from the location field 630.

Returning back to FIG. 4, at operation 450, the job ingestion module 206 can receive XML feeds from partner companies. The partner companies can have a direct XML feeds of their job listings, and the XML feeds can map to the social network job listing site. For example, utilizing partnership with some entities can allow for access to the entities' XML feeds, and the XML feeds can be directly mapped to generate job listings at operation 460.

At operation 460, the job ingestion module 206 can generate job listings on the social network system 210 based on the extracted fields. Additionally, the job ingestion module 206 can generate additional job listings on the social network system 210 based on the received XML feeds.

At operation 470, the basic jobs can be standardized. In some instances, the job ingestion module 206 can fill in missing features using member data 218 and job listing data 220.

For example, before the generated job listings can be indexed and visible on the social network system 210, the job ingestion module 206 may first extract the following fields using classifiers: job functions; standardized company; industry; employment type; and seniority. The standardized company can map to a company page in the profile data 212. The employment type (e.g., full time, part time, or internship) can be parsed out of the job description. The seniority can be derived from the job title and an internal mapping of job title in relation to seniority.

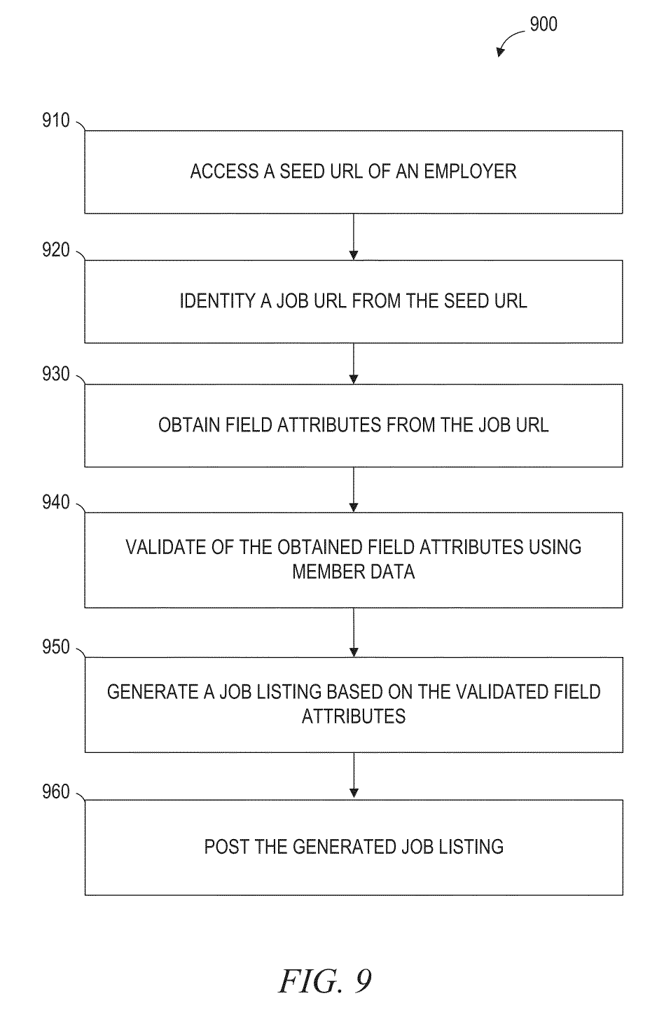

Additionally, at operation 470, the generated jobs can be filtered using a spam classifier to remove low quality job listings. FIG. 9 further describes techniques for validating a job listing based on member data 218 in order to ensure high quality jobs are listed on the social network system 210.

Furthermore, at operation 470, the job ingestion module 206 can filter out jobs with the same title, company, and location to prevent duplicates from being posted on the social network system 210.

At operation 480, the standardized jobs are indexed to allow the jobs to be searched. For example, the job ingestion module 206 can save all the data in the search index, so that the generated job listings can be searchable.

Moreover, after ingesting jobs form a job URL 135, the job ingestion module 206 can check to ensure that all of the jobs in the job URL 135 have been ingested. The job ingestion module 206, using a verification process and machine learning techniques, can ensure that the locations are mapped and fields are being extracted properly. The job ingestion module 206 can ccontinuously monitor job volatility by periodically updating the information associated with the specific URL 510, as sites can be updated.

FIG. 9 is a flowchart illustrating operations of the job ingestion module 206 in performing a method 900 for ingesting a job listing, according to some example embodiments. Operations in the method 900 may be performed by network-based system 105, using modules described above with respect to FIGS. 2-3. As shown in FIG. 9, the method 900 includes operations 910, 920, 930, 940, 950 and 960.

At operation 910, the job ingestion module 206 can access a seed URL of an employer. The seed URL can be the company URL 130. The company URL 130 can be accessed by the job ingestion module 206 using the network 190. The company URL 130 can be mined using the techniques described at operation 410 (FIG. 4).

At operation 920, the job ingestion module 206 can identify a job URL from the seed URL. For example, the company URL 130 can have a job URL 135, where the job URL 135 includes job listings for the company. The job ingestion module 206 can identify the job URL 135 from the company URL 130 using the techniques described at operation 420.

At operation 930, the job ingestion module 206 can obtain field attributes from the job URL 135. The job ingestion module 206 can obtain field attributes from the job URL 135 using the techniques described at operations 430 and 440. Additionally, FIG. 6 illustrates an example of field attributes being obtained from a job URL 135.

At operation 940, the job ingestion module 206 can validate the obtained field attributes using member data 218. In some instances, to ensure the accuracy and authenticity of the job listings posted on the social network system 210, the job ingestion module 206 can access member data 218 (e.g., a company page corresponding to the employer) to determine the validity of the obtained field attributes. For example, if a job listing is associated with a company that does not have a company page in the profile data 212 of the social network system 210, then the job ingestion module 206 can discard the retrieved job listing. Additionally, the location, job title, seniority, job description can be validated based on the member data 218 associated with the company.

Furthermore, the job ingestion module 206 can use job listing data 220 to determine the validity of the obtained field attributes. For example, the salary, job title, seniority, and job description can be verified using job listing data 220 from the same company or job listing data 220 from competitors.

At operation 950, the job ingestion module 206 can generate a job posting based on the validated field attributes. The job ingestion module 206 can use the techniques described at operation 460 to generate the job listing.

At operation 960, the job ingestion module 206 can post the generated job listing. In some instances the posting at operation 960 can include filling in missing field attributes in the generated job listing. For example, if a job location is missing from the information in the job URL, the job ingestion module 206 can determine the job location using member data 218 and the API discussed at operation 440 that maps raw location strings to standardized cities, states, countries, and postal codes.

Additionally, the job ingestion module 206 can use the techniques described at operation 470 to standardize the generated job listing before posting the job listing. For example, standardizing can include formatting (e.g., font change, indentation, and spacing) the job listing so that the job listing format is similar to other job listings in the social network system 210.

Furthermore, the social network system 210 can have a process of standardizing companies. Using the standardized company list, the determination module 211 can determine the company associated with the job listing. Once the company is determined, the job ingestion module 206 can access profile data 212 for the determined company from the company page (e.g., company URL 130). Furthermore, the accessed member data 218 can include social graph data 214, which can include the connections of the employees associated with the company page. Moreover, the accessed member data 218 can include member activity and behavior data 216, which can include the page views of the job listing, page views of similar job listings, page views of job listings for the determined company, administration rights for the company page associated with the determined company, and creation of paid job postings on the social network system 210.

For each job listing received by the management node 301, a unique identification (ID) can be generated using an idempotent function. The unique ID can be called the global ID that can be associated with a job code. The management node 301 can determine if the global ID exists in the database 115.

If the global ID does not exist in the database 115, then the job listing can be created. For example, the management node 301 can generate the job listing using a publish-subscribe messaging service (e.g., REST API).

Alternatively, if the global ID of the new job listing does exist (e.g., a current job listing has the same global ID), the management node 301 can generate a hash of the current job and the new job. If the hash is different, then the management node 301 can update the job listing by using the publish-subscribe messaging service. If the hash is the same, then the management node 301 can update the job listing when a predetermined amount of time (e.g., 15 days) has elapsed since last update.

For example, if a job listing has not changed since the last time it was accessed by the management node 301, then the management node 301 checks the last time the job listing was sent through the publish-subscribe messaging service. When the job listing has been sent through the publish-subscribe messaging service for less than a predetermined amount of time, then the job listing is still considered valid and is not updated. Alternatively, if it has been more than a predetermined amount of time that the job listing has been sent through the publish-subscribe messaging service, then the job listing can be updated. Updating the job listing can also ensure that the job listing is automatically updated when an extended amount of time (e.g., one month) has elapsed between updates.

Subsequently, the ingestion node 311 can send a notification to the management node 301 that the ingestion of the job listing is finished. Once the management node 301 receives the notification, the management node 301 can generate a difference report of the previous ingestion (e.g., current job listing) from the latest ingestion (e.g., new job listing). The difference report can list jobs that have been removed or deleted from the external site.

Additionally, the management node 301 can transmit a partial update API call to update the status of a job to “closed” based on the difference report. For example, a job listing can be “closed” when the job listing has not been updated for an extended amount of time (e.g., one month).

Furthermore, the ingestion process (e.g., method 400, and method 900) described above can be repeated periodically (e.g., 24 hours) by the job ingestion module 206.

In some instances, rule creation and rule verification can allow for code-free ingestion of job listings by the job ingestion module 206. Rule creation allows an analyst to process a dump of raw HTML from ingestion. The analyst interface module 202 allows the analyst to select certain elements on the page, which in turn generates a rule behind the scenes. Rule verification can take the rules created by another analyst and allow a new analyst to verify that the rules are indeed working. Once a rule has been verified, the task is removed from an analyst's queue.

The job ingestion module 206 can be scalable using a hash-checking algorithm, asynchronous messaging library, load balancer, and a system-level virtualization method to provision new nodes (e.g., management node 301, ingestion node 311).

Using a hash-checking algorithm as described in the ingestion process (e.g., method 400, and method 900), the management node 301 can ignore job listings that have not been updated. Additionally, the management node 301 can ignore job listings that have not been resent through the publish-subscribe messaging service queue for a predetermined amount of time (e.g., in the last 15 days). This can lower the amount of publish-subscribe messaging service queuing calls without sacrificing the consistency of the jobs index.

Using a high-performance asynchronous messaging library can provide a message queue without a dedicated message broker. For example, using an asynchronous message queuing pipeline, the ingestion node 311 can send back job listings asynchronously, using a pool of sockets (e.g., 50 sockets). Each ingestion node 311 can then send back job listings through these sockets instead of over HTTP, which can speed up the process by eight-fold. Additionally, the ingestion process (e.g., method 400, and method 900) can be sped up even further by increasing the number of sockets used.

Additionally, the management nodes (e.g., management nodes 301-304) can be situated behind a load balancer, which allows for easy scaling of the management nodes.

Furthermore, the ingestion process (e.g., method 400, and method 900) can be implemented with a custom in-house system that makes use of an operating system-level virtualization method to provision new nodes. The virtualization method can run multiple isolated operating systems (e.g., containers) on a single control host. A single control host may be used to easily generate new nodes and analyze statistics about each node.

To enhance security, sections of the analyst interface module 202 and metric analytics module 209 can have different levels of access. For example, administrators may have a higher level of access than analysts. Additionally, an analyst 152) may be grouped by location and have access to the job listings specific to the location.

Additionally, the endpoints can be secured with a cross-site request forgery (CSRF) token to protect against CSRF attacks.

FIG. 10 illustrates an interface 1010 for an administrator to manage the workflow for a team of analysts (e.g., analyst 152). For example, the administrator can delegate a first analyst to verify the extracted information from the company URL 130 of company A 1020.

According to various example embodiments, one or more of the methodologies described herein may facilitate the ingestion of job listings from third-party websites (e.g., third-party URL 120, company URL 130).

When these effects are considered in aggregate, one or more of the methodologies described herein may obviate a need for certain human efforts or resources that otherwise would be involved in ingesting job listings. Additionally, computing resources used by one or more machines, databases, or devices (e.g., within the network environment 100) may similarly be reduced. Examples of such computing resources include processor cycles, network traffic, memory usage, data storage capacity, power consumption, and cooling capacity.

FIG. 11 is a block diagram illustrating components of a machine 1100, according to some example embodiments, able to read instructions 1124 from a machine-readable medium 1122 (e.g., a non-transitory machine-readable medium, a machine-readable storage medium, a computer-readable storage medium, or any suitable combination thereof) and perform any one or more of the methodologies discussed herein, in whole or in part. Specifically, FIG. 11 shows the machine 1100 in the example form of a computer system (e.g., a computer) within which the instructions 1124 (e.g., software, a program, an application, an applet, an app, or other executable code) for causing the machine 1100 to perform any one or more of the methodologies discussed herein may be executed, in whole or in part.

In alternative embodiments, the machine 1100 operates as a standalone device or may be connected (e.g., networked) to other machines. In a networked deployment, the machine 1100 may operate in the capacity of a server machine or a client machine in a server-client network environment, or as a peer machine in a distributed (e.g., peer-to-peer) network environment. The machine 1100 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1124, sequentially or otherwise, that specify actions to be taken by the machine 1100. Further, while only a single machine 1100 is illustrated, the term “machine” shall also be taken to include any collection of machines that individually or jointly execute the instructions 1124 to perform all or part of any one or more of the methodologies discussed herein.

The machine 1100 includes a processor 1102 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1104, and a static memory 1106, which are configured to communicate with each other via a bus 1108. The processor 1102 may contain microcircuits that are configurable, temporarily or permanently, by some or all of the instructions 1124 such that the processor 1102 is configurable to perform any one or more of the methodologies described herein, in whole or in part. For example, a set of one or more microcircuits of the processor 1102 may be configurable to execute one or more modules (e.g., software modules) described herein.

The machine 1100 may further include a graphics display 1110 (e.g., a plasma display panel (PDP), a light emitting diode (LED) display, a liquid crystal display (LCD), a projector, a cathode ray tube (CRT), or any other display capable of displaying graphics or video). The machine 1100 may also include an alphanumeric input device 1112 (e.g., a keyboard or keypad), a cursor control device 1114 (e.g., a mouse, a touchpad, a trackball, a joystick, a motion sensor, an eye tracking device, or another pointing instrument), a storage unit 1116, an audio generation device 1118 (e.g., a sound card, an amplifier, a speaker, a headphone jack, or any suitable combination thereof), and a network interface device 1120.

The storage unit 1116 includes the machine-readable medium 1122 (e.g., a tangible and non-transitory machine-readable storage medium) on which are stored the instructions 1124 embodying any one or more of the methodologies or functions described herein. The instructions 1124 may also reside, completely or at least partially, within the main memory 1104, within the processor 1102 (e.g., within the processor's 1102 cache memory), or both, before or during execution thereof by the machine 1100. Accordingly, the main memory 1104 and the processor 1102 may be considered machine-readable media (e.g., tangible and non-transitory machine-readable media). The instructions 1124 may be transmitted or received over the network 190 via the network interface device 1120. For example, the network interface device 1120 may communicate the instructions 1124 using any one or more transfer protocols (e.g., HTTP).

In some example embodiments, the machine 1100 may be a portable computing device, such as a smartphone or tablet computer, and have one or more additional input components 1130 (e.g., sensors or gauges). Examples of such input components 1130 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components 1130 may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1122 is shown in an example embodiment to be a single medium, the term “machine-readable medium” should be taken to include a single medium or multiple media (e.g., a centralized or distributed database, or associated caches and servers) able to store the instructions 1124. The term “machine-readable medium” shall also be taken to include any medium, or combination of multiple media, that is capable of storing the instructions 1124 for execution by the machine 1100, such that the instructions 1124, when executed by one or more processors of the machine 1100 (e.g., processor 1102), cause the machine 1100 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. As used herein, “processor-implemented module” refers to a hardware module in which the hardware includes one or more processors. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a company uniform resource locator (URL) associated with the company;
determining a job URL from the accessed company URL, the job URL having a plurality of job postings;
obtaining job attributes for a job posting from the plurality of job postings;
accessing, from a social network system, member data associated with the company;
validating, using a job ingestion module, the obtained job attributes using the accessed member data;
generating a job listing for the job posting based on the validated field attributes; and
storing, in a database of the social network system, the generated job listing, the database having a plurality of stored job listings based on job postings from a plurality of companies.

2. The method of claim 1 further comprising:
determining a company page on the social network system, the company page corresponding to the company; and
posting the generated job listing on the company page.

3. The method of claim 2 further comprising:
adding a missing job attribute to the posted job listing, the missing job attribute being determined based on the member data.

4. The method of claim 3, wherein the missing job attribute is a salary range based on job listing data from another generated job listing associated with the company.

5. The method of claim 3, wherein the missing job attribute is a job location based on information from the company page.

6. The method of claim 1 further comprising:
removing the stored job listing corresponding to the generated job listing when the company is not associated with a company page in the social network.

7. The method of claim 1, wherein the member data is assessed from corresponding member profiles in the social network system, and wherein the corresponding member profiles list the company as a current employer.

8. The method of claim 1, wherein the database includes a list of global identifiers, and the method further comprising:
generating an identifier for the generated job listing using an impotent function; and
determining that the list of global identifiers does not include the generated identifier, the method further includes:
posting the generated job listing on the social network system;
updating the list of global identifiers to include the generated identifier; and
creating an association between the generated identifier and the generated job listing in the database.

9. The method of claim 8, further comprising:
determining that the generated identifier matches a global identifier from the list of global identifiers, the method further includes:
generating a hash for the generated job listing;
comparing, using an hash-checking algorithm, the generated hash with a stored hash in the database, the stored hash corresponding to the global identifier;
updating the stored hash in the database to equal the generated hash when the comparison of the generated has does not equal the stored hash; and
posting the generated job listing on the social network system when the comparison of the generated hash does not equal the stored hash.

10. The method of claim 8, further comprising:
determining that the generated identifier matches a global identifier from the list of global identifiers, the method further includes:
generating a hash for the generated job listing;
comparing, using an hash-checking algorithm, the generated hash with a stored hash in the database, the stored hash corresponding to the global identifier;
determining, when the comparison of the generated hash does equal the stored hash, an amount of time since a stored job listing corresponding to the global identifier was updated;
updating the stored job listing corresponding to the generated job listing when the determined amount of time is greater than a predetermined threshold; and
posting the generated job listing stored on the social network system when the determined amount of time is greater than a predetermined threshold.

11. The method of claim 8, further comprising:
determining that the generated identifier matches a global identifier from the list of global identifiers, the method further includes:
generating a hash for the generated job listing;
comparing, using an hash-checking algorithm, the generated hash with a stored hash in the database, the stored hash corresponding to the global identifier;
determining, when the comparison of the generated hash does equal the stored hash, an amount of time since a stored job listing corresponding to the global identifier was updated; and
removing the stored job listing corresponding to the generated job listing when the determined amount of time is less than a predetermined threshold.

12. The method of claim 1, wherein the job attributes include a job title, a job skill, a job function, and industry information.

13. A system comprising:
an access module configured to access a company uniform resource locator (URL) associated with the company;
a job ingestion module, using a processor, configured to:
determine a job URL from the accessed company URL, the job URL having a plurality of job postings;
obtain job attributes for a job posting from the plurality of job postings;
access, from a social network system, member data associated with the company;
validate, using a job ingestion module, the obtained job attributes using the accessed member data; and
generate a job listing for the job posting based on the validated field attributes; and
a database configured to store the generated job listing, the database having a plurality of stored job listings based on job postings from a plurality of companies.

14. The system of claim 13, wherein the job ingestion module is further configured to:
determine a company page on the social network system, the company page corresponding to the company; and
post the generated job listing on the company page.

15. The system of claim 14, wherein the job ingestion module is further configured to:
add a missing job attribute to the generated job listing, the missing job attribute being determined based on the member data.

16. The system of claim 15, wherein the missing job attribute is a salary range based on job listing data from another generated job listing associated with the company.

17. The system of claim 13, wherein the job ingestion module is further configured to:
remove the stored job listing corresponding to the generated job listing when the company is not associated with a company page in the social network.

18. The system of claim 13, wherein the member data is assessed from corresponding member profiles in the social network system, and wherein the corresponding member profiles list the company as a current employer.

19. The system of claim 13, wherein the job attributes include a job title, a job skill, a job function, and industry information.

20. A non-transitory machine-readable storage medium comprising instructions that, when executed by one or more processors of a machine, cause the machine to perform operations comprising:
accessing a company uniform resource locator (URL) associated with the company;
determining a job URL from the accessed company URL, the job URL having a plurality of job postings;
obtaining job attributes for a job posting from the plurality of job postings;
accessing, from a social network system, member data associated with the company;
validating, using a job ingestion module, the obtained job attributes using the accessed member data;
generating a job listing for the job posting based on the validated field attributes; and
storing, in a database of the social network system, the generated job listing, the database having a plurality of stored job listings based on job postings from a plurality of companies.
